(19) United States
(12) Patent Application Publication
(10) Pub. No.: US 2015/0043113 A1
(43) Pub. Date: Feb. 12, 2015

(54) ESD CLAMP CIRCUIT

(71) Applicants: TAIWAN SEMICONDUCTOR MANUFACTURING CO., LTD., Hsin-Chu (TW); GLOBAL UNICHIP CORPORATION, Hsinchu City (TW)

(72) Inventors: Tsai-Ming Yang, Tainan City (TW); Yen-Chung Chen, Sunnyvale, CA (US); Jen-Tai Hsu, Miaoli County (TW); Yi-Lin Lee, Tainan City (TW)

(73) Assignees: TAIWAN SEMICONDUCTOR MANUFACTURING CO., LTD., Hsin-Chu (TW); GLOBAL UNICHIP CORPORATION, Hsinchu City (TW)

(21) Appl. No.: 13/959,865

(22) Filed: Aug. 6, 2013

(51) Int. Cl. H02H 9/04

(52) U.S. Cl. CPC H02H 9/046
USPC 361/56

(57) ABSTRACT

ESD clamp circuit is provided, including an RC circuit, a first transistor, a second transistor, an ESD conduction unit and an inverter. The first transistor has a gate and a drain respectively coupled to the RC circuit and a control terminal of the ESD conduction unit. The inverter has an input terminal coupled to the control terminal. The second transistor has a drain and a gate respectively coupled to the control terminal and an output terminal of the inverter. The gates of the first and second transistors are isolated; also the output terminal and the gate of the first transistor are isolated.

### FIELD OF THE INVENTION

The present invention relates to an ESD (Electro-Static Discharge) clamp circuit, and more particularly, to an ESD clamp circuit with improved ESD protection.

### BACKGROUND OF THE INVENTION

ESD protection is essential for semiconductor apparatus, such as integrated circuit, die, chip and SoC (System on Chip), etc. Semiconductor apparatus has conductive interface, like metal pins or solder balls, for signal input/output and power supply; however, the conductive interface also provides potential electrical paths which conduct external charges of ESD into internal circuitry (e.g., core devices/elements such as transistors) of semiconductor apparatus. To protect the internal circuitry from damage of ESD, semiconductor apparatus is equipped with ESD clamp circuits.

ESD clamp circuit is deployed between power rails which are arranged to relay supply power for a semiconductor apparatus; when ESD zaps the semiconductor apparatus and rapidly accumulates a huge voltage difference across the power rails, the ESD clamp circuit is expected to provide a temporary low-impedance path between the power rails, such that charges of ESD can be released from one power rail to another power rail, and hence the voltage across the power rails can be clamped below a tolerable threshold, e.g., a core device stress voltage. On the other hand, when the semiconductor apparatus normally powers up and builds supply voltages across the power rails, the ESD clamp circuit is expected to stop conducting between the power rails.

Please refer to FIG. 1 and FIG. 2 respectively show two known ESD clamp circuits 10 and 20. The ESD clamp circuits 10 and 20 are coupled between nodes nv1 and nv2 of two power rails which respectively relay supply voltages VDD and VSS. The ESD clamp circuit 10 includes a resistor R1, a capacitor C1 and a transistor MN, e.g., an n-channel MOS (Metal-Oxide-Semiconductor) transistor. The transistor MN has a gate, a drain and a source respectively coupled to nodes ng1, nv1 and nv2. When ESD occurs and rapidly raise voltage of the node nv1 against the node nv2, voltage of the node ng1 follows to rise, so the transistor MN is turned on and conducts the node nv1 to the node nv2 for ESD clamping. During normal power-up, the capacitor C1 has sufficient time to be charged to accumulate voltage difference between the nodes nv1 and ng1, so voltage of the node ng1 is substantially kept the same as that of the node nv2, and the transistor MN is kept off.

In addition to an ESD transistor MN, a resistor R2 and a capacitor C2, the ESD clamp circuit 20 further includes two transistors Mp1 and Mn1 forming an inverter 22. Gates of the transistors Mp1 and Mn1 are commonly coupled to a node ng0, and gate of the transistor MN is coupled to a node ng1. When ESD occurs and rapidly raise voltage of the node nv1 against the node nv2, voltage of the node ng0 is kept closed to voltage of the node nv2 due to slow response of the capacitor C2, therefore the transistor Mn1 and Mp1 are respectively turned off and on, voltage of the node ng1 is pulled high by the turned-on transistor Mp1, and the transistor MN is triggered to conduct between the nodes nv1 and nv2 for ESD clamping. During normal power-up, the capacitor C2 has sufficient time to be charged to accumulate voltage difference between the nodes nv2 and ng0, so voltage of the node ng0 is substantially kept the same as that of the node nv1; the transistors Mn1 is thus turned on to conduct between the nodes ng1 and nv2, and hence keeps the transistor MN turned off.

U.S. Pat Nos. such as 5,946,177, 7,570,468 and 7,164,565 also disclose various kinds of ESD clamp circuits. However, the aforementioned prior arts fail to extend duration of ESD protection. Taking the typical ESD clamp circuit 20 (FIG. 2) as an example: after ESD event starts, the ESD clamp circuit 20 eventually terminates ESD protection when voltage of the node ng1 transits from high to low. Because voltage of the node ng1 is controlled by the inverter 22, voltage transition of the node ng1 depends on transfer curve of the inverter 22. However, the transfer curve of the inverter 22 includes a section when both the transistors Mp1 and Mn1 are turned on, and duration of ESD protection is therefore compromised.

### SUMMARY OF THE INVENTION

To address issues of the prior arts, an objective of the invention is providing an ESD clamp circuit which includes an RC circuit, a first transistor, a second transistor, an inverter and an ESD conduction unit. The RC circuit includes a first terminal, a second terminal and a detection terminal; the first terminal and the second terminal are respectively coupled to a first power node and a second power node. The first transistor includes a first source, a first gate and a first drain; the first source and the first gate are respectively coupled to the first power node and the detection terminal. The ESD conduction unit includes a third terminal, a fourth terminal and a control terminal respectively coupled to the first power node, the second power node and the first drain, wherein the ESD conduction unit is arranged to selectively conduct between the third terminal and the fourth terminal in response to a signal of the control terminal. The inverter includes an input terminal and an output terminal; the input terminal is coupled to the control terminal. The second transistor includes a second source, a second gate and a second drain respectively coupled to the second power node, the output terminal of the inverter and the control terminal. Wherein the first gate and the second gate are isolated (i.e., electrically open-circuit), the output terminal of the inverter and the first gate are also isolated. In an embodiment, the first transistor and the second transistor are respectively a p-channel transistor and an n-channel MOS transistor.

In an embodiment, the inverter includes a third transistor and a fourth transistor. The third transistor includes a third source, a third gate and a third drain respectively coupled to the first power node, the input terminal and the output terminal. The fourth transistor includes a fourth source, a fourth gate and a fourth drain respectively coupled to the second power node, the input terminal and the output terminal.

In an embodiment, the ESD conduction unit includes a fifth transistor which includes a fifth source, a fifth gate and a fifth drain respectively coupled to the second power node, the control terminal and the first power node.

In an embodiment, the RC circuit includes a resistor and a capacitor. The resistor is coupled between the first power node and the detection terminal, and the capacitor is coupled between the detection terminal and the second power node.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 and FIG. 2 (prior arts) respectively illustrate two conventional ESD clamp circuits;

FIG. 3 illustrates an ESD clamp circuit according to an embodiment of the invention; and

FIG. 4 compares ESD protection performances of different ESD protection circuits.

### DETAILED DESCRIPTION OF PREFERRED EMBODIMENTS

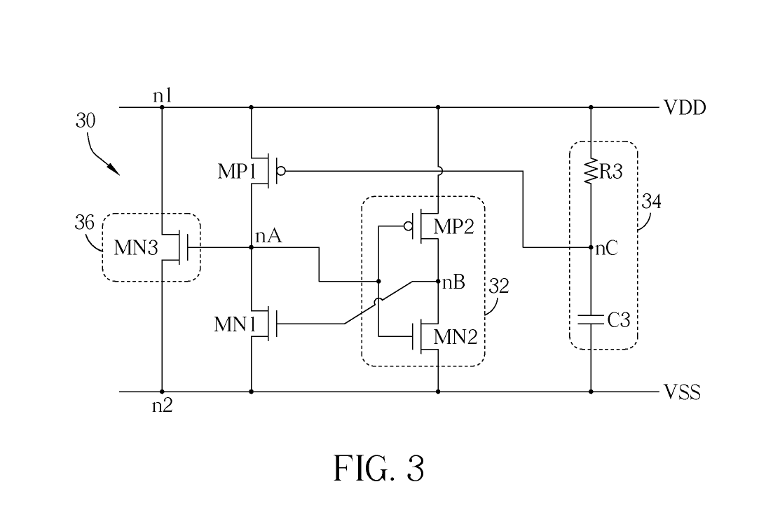

Please refer to FIG. 3 illustrating an ESD clamp circuit 30 according to an embodiment of the invention. The ESD clamp circuit 30 includes an RC circuit 34, transistors MP1 and MN1, an inverter 32 and an ESD conduction unit 36. The RC circuit 34 includes three terminals respectively couples to nodes n1, n2 and nC. For example, the nodes n1 and n2 can be regarded as two power nodes of two power rails which respectively relay two supply voltages VDD and VSS, and the node nC can be regarded as a detection terminal. The transistor MP1, e.g., a p-channel MOS transistor, has a source, a gate and a drain respectively coupled to nodes n1, nC and nA. The ESD conduction unit 36 includes three terminals respectively coupled to the node n1, n2 and nA; the node nA can be regarded as a control terminal, and the ESD conduction unit 36 is arranged to selectively conduct between the nodes n1 and n2 in response to a signal of the node nA. The inverter 32 includes an input terminal and an output terminal respectively coupled to the node nA and a node nB. The transistor MN1 has a source, a gate and a drain respectively coupled to the nodes n2, nB and nA. Note that gates of the transistors MP1 and MN1 (respectively at the nodes nC and nB) are isolated, the output terminal of the inverter 32 (at the node nB) and gate of the transistor MP1 (at the node nC) are also isolated.

The inverter 32 can include two transistors MP2 and MN2. The transistor MP2, e.g., a p-channel MOS transistor, has a source, a gate and a drain respectively coupled to the nodes n1, nA and nB. The transistor MN2 has a source, a gate and a drain respectively coupled to the nodes n2, nA and nB.

In an embodiment, the ESD conduction unit 36 includes an n-channel transistor, which has a source, a gate and a drain respectively coupled to the n2, nA and n1. The ESD conduction unit 36 can also be formed by other element which can be selectively controlled to conduct, such as an SCR (Silicon-Controlled Rectifier).

The RC circuit 34 includes a resistor R3 and a capacitor C3. The resistor R3 is coupled between the nodes n1 and nC, and the capacitor C3 is coupled between the node nC and n2.

When ESD happens and rapidly raises voltage of the node n1, voltage of the node nC becomes relatively low since the capacitor C3 slows down voltage change of the node nC. The transistor MP1 is therefore turned on to conduct between the nodes n1 and nA, and voltage of the node nA is also raised to track voltage of the node n1. Accordingly, the transistor MN3 is turned on to conduct between the nodes n1 and n2 for ESD clamping.

At the same time, the inverter 32 keeps a low voltage at the node nB in response to the high voltage at the node nA, so the transistor MN1 remains off. Isolation between the nodes nB and nC helps to extend ESD protection (e.g., turn-on duration of the transistor MN3), because the transistor MN1 has to wait for the transistor MP1 to turn off and the inverter 32 to transit, then the transistor MN1 is turned on to turn off the transistor MN3.

During normal power-up, the RC circuit 34 has sufficient time to allow voltage of the node nC to track a relatively slower (comparing to ESD) supply voltage rising of the node n1, so the transistors MP1 is kept off, and the transistor MN1 will eventually be turned on to prevent conduction of the ESD conduction unit 36.

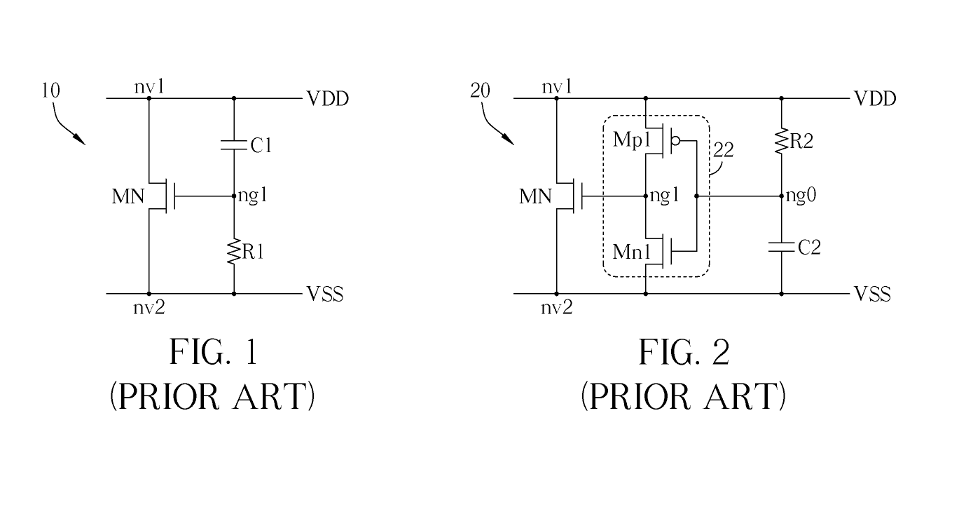

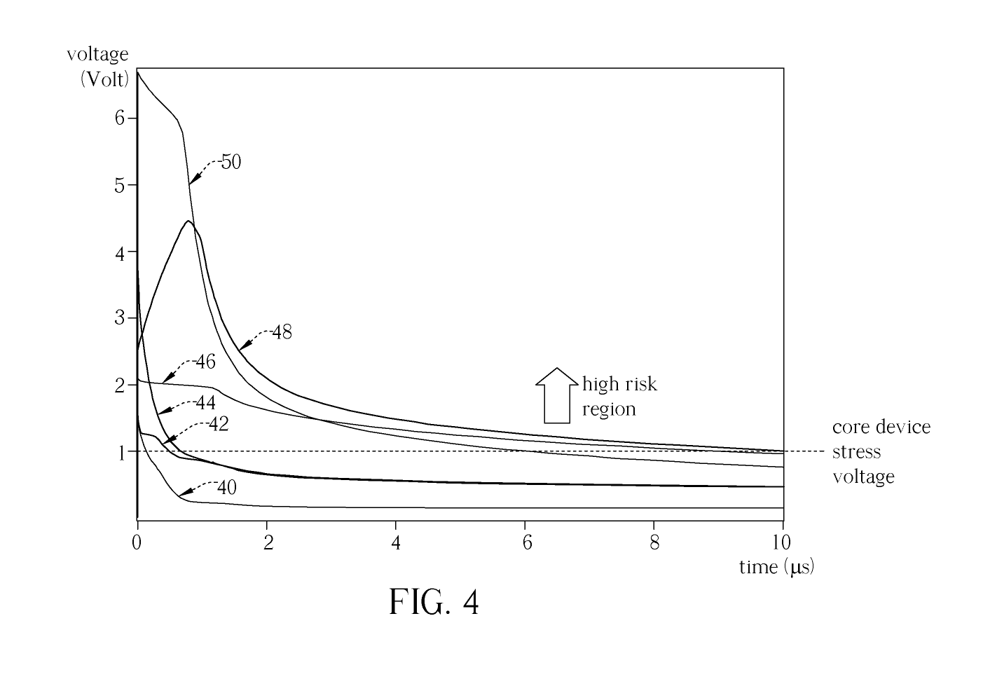

Please refer to FIG. 4 which compares ESD protection performances of different ESD clamp circuits by curves 40 to 48; the transverse axis is time, and the longitudinal axis is voltage difference between two power rails. In response to an ESD event starts at time 0, each of the curves 40 to 50 illustrates how a corresponding ESD clamp circuit clamps the voltage difference between two power rails with time. The curve 40 demonstrates ESD protection performance of the ESD clamp circuit 30 (FIG. 3) of the invention. The curves 44 and 48 respectively demonstrate performances of the ESD clamp circuits 10 and 20 (FIG. 1 and FIG. 2). The curves 42, 46 and 50 respectively emulate performances of the ESD clamp circuits mentioned in U.S. Pat. Nos. 5,946,177, 7,164,565 and 7,570,468. As shown in FIG. 4, the ESD clamp circuit 30 of the invention can clamp the voltage difference lower below the core device stress voltage faster and longer, while other known ESD clamp circuits expose the core devices to high risk region where the voltage difference is above the core device stress voltage.

To sum up, by proper circuitry architecture and arrangement, the ESD clamp circuit of the invention provides improved ESD protection comparing to various known ESD clamp circuits. Also the ESD clamp circuit of the invention is area-efficient, since the ESD clamp circuits mentioned in U.S. Pat. Nos. 5,946,177 and 7,570,468 demand extra layout areas for additional elements.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An ESD (electro-static discharge) clamp circuit comprising:
an RC circuit comprising a first terminal, a second terminal and a detection terminal; the first terminal and the second terminal respectively coupled to a first power node and a second power node;
a first transistor comprising a first source, a first gate and a first drain;
the first source and the first gate respectively coupled to the first power node and the detection terminal;
an ESD conduction unit comprising a third terminal, a fourth terminal and a control terminal respectively coupled to the first power node, the second power node and the first drain; wherein the ESD conduction unit is arranged to selectively conduct between the third terminal and the fourth terminal in response to a signal of the control terminal;
an inverter comprising an input terminal and an output terminal; the input terminal coupled to the control terminal; and
a second transistor comprising a second source, a second gate and a second drain respectively coupled to the second power node, the output terminal of the inverter and the control terminal;
wherein the first gate and the second gate are isolated.

2. The ESD clamp circuit of claim 1, wherein the output terminal of the inverter and the first gate are isolated.

3. The ESD clamp circuit of claim 1, wherein the inverter comprises:
a third transistor comprising a third source, a third gate and a third drain respectively coupled to the first power node, the input terminal and the output terminal; and
a fourth transistor comprising a fourth source, a fourth gate and a fourth drain respectively coupled to the second power node, the input terminal and the output terminal.

4. The ESD clamp circuit of claim 1, wherein the ESD conduction unit comprises a fifth transistor which comprises a fifth source, a fifth gate and a fifth drain respectively coupled to the second power node, the control terminal and the first power node.

5. The ESD clamp circuit of claim 1, wherein the RC circuit comprises:
a resistor coupled between the first power node and the detection terminal, and
a capacitor coupled between the detection terminal and the second power node.

6. The ESD clamp circuit of claim 1, wherein the first transistor and the second transistor are respectively a p-channel transistor and an n-channel transistor.
